(19) United States
(12) Patent Application Publication
(10) Pub. No.: US 2002/0026734 A1
(43) Pub. Date: Mar. 7, 2002

(54) LCD-pixel matrix element based, LCD-display screen capable of graphics, with a plurality of such LCD-pixel matrix elements and a procedure for brightness control of such an LCD-pixel matrix element

(75) Inventors: Reiner Bayrle, Langenau (DE); Thomas Bitter, Ditzenbach (DE); Otto Bader, Warthausen (DE)

Correspondence Address: Jeffrey M. Karmilovich, DORITY & MANNING, P.A., Post Office Box 1449, Greenville, SC, 29602, US

(73) Assignee: AEG Gesellschaft fur moderne Informationssysteme mbH

(21) Appl. No.: 09/790,999

(22) Filed: Feb. 22, 2001

(30) Foreign Application Priority Data
Feb. 24, 2000 (DE) 20003356.5
May 12, 2000 (DE) 10023378.3

(51) Int. Cl. G02F 1/13; G02F 1/133; G09F 9/00

(52) U.S. Cl. 40/448; 349/1; 349/19

(57) ABSTRACT

An LCD-pixel-matrix element is disclosed, along with a display screen capable of graphics having a plurality of such LCD-pixel-matrix elements, and a procedure for brightness control of such an LCD-pixel matrix element for such a display screen.

The invention concerns an LCD-pixel-matrix element, a display screen capable of graphics with a plurality of such LCD-pixel-matrix elements and a procedure for brightness control of such an LCD-pixel-matrix element or such a display screen. For instance, railroad practices make it desirable to have large surfaced display screens capable of graphics available, in order to provide to the railroad customers, and passengers definite information regarding departure times, placement of cars, location of the diner car, arrival time and the like. Such displays are to be found at the present time in open areas, and partially in buildings, where the displays are subjected to various lighting conditions and ambient illumination. Known LCD-pixel-matrix elements exhibit the disadvantage, that under conditions of such differing illumination, the contrast undergoes very severe swings of visibility and thus the legibility is not always an assured matter. EP 0 389 744 discloses such an LCD-pixel-matrix element

Thus it is the purpose of the present invention to make available an LCD-pixel-matrix element, a display screen capable of graphics with a plurality of such LCD-pixel-matrix elements and a procedure for brightness regulation, i.e. contrast control, for these components.

The achievement of this purpose is accomplished by the features of the Claims 1, 2 or 12.

So that, the LCD control voltage can be varied to correspond with the ambient brightness, the LCD control voltage at brighter ambient light can be pushed to even higher levels, whereby the transmission ability of the LCD display increases. By this means, the display appears brighter and is easier to read at such high ambient illumination. In this way, such a display is particularly well suited for outside use, where, because of natural conditions, very often variations in the incident brightness occur.

Alternatively, better legibility may also be attained, when the ratio of light-active surface to the entire display area lies between 50 and 87%, particularly better in a range between 60 and 85%, whereby a pixel density of from two to three pixels per square centimeter is provided. It has been empirically found, in the case of a LCD-pixel-matrix within these ranges, that the legibility is better than in ratios outside of these limitations.

In accord with an advantageous embodiment of the invention, the display surface is rectangular, and the single pixels are arranged in columns and lines. The connection elements and the integrated circuits of the control are, in these cases, in the upper and the lower edge areas, whereby a plurality of such LCD-pixel-matrix elements can be placed next to one another, in order to create a greater display surface. In accord with another advantageous embodiment of the invention, the pixels are combined in color groups, to enable the presentation of information in color.

In accord with yet another advantageous embodiment of the invention, a plurality of LCD-pixel-matrix elements are placed beside one another, or below one another, whereby, an LCD-screen capable of graphics is made possible.

In accord with another advantageous embodiment of the invention, the display screen, i.e, the single LCD-pixel-matrix elements are protected by means of a transparent cover, i.e. an overlay. This transparent cover is provided with anti-glare means. By this means, more light reaches the LCD-design and additionally, the intensity of the disturbing reflections is diminished. As a result, the brightness and the contrast of the LCD-display become greater.

The remaining subordinate claims are concerned with further advantageous embodiments of the invention.

Further details, features and advantages of the invention are provided by the following description of preferred embodiments illustrated with the aid of the drawings.

There is shown in:

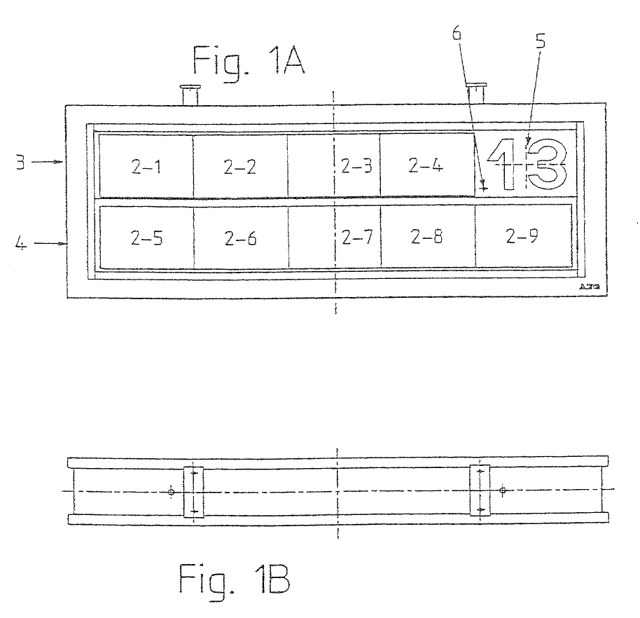

FIG. 1A a front view of an example embodiment of a display screen capable of graphics in accord with the present invention,

FIG. 1B a top view of the display screen shown in FIG. 1A,

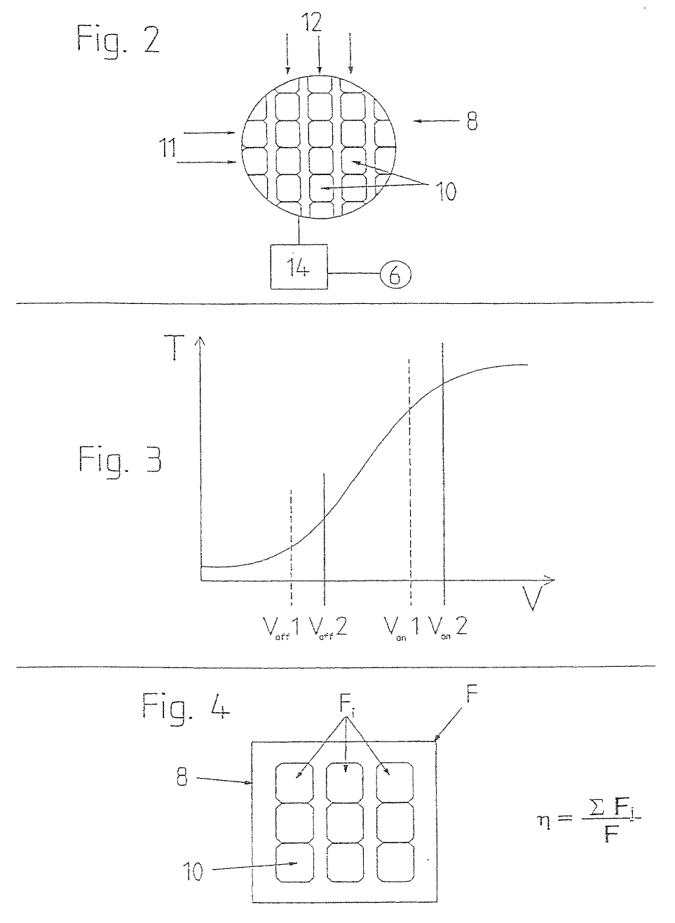

FIG. 2 a block illustration of the brightness control in accord with the present Invention,

FIG. 3 a graph for the explanation of the brightness curve,

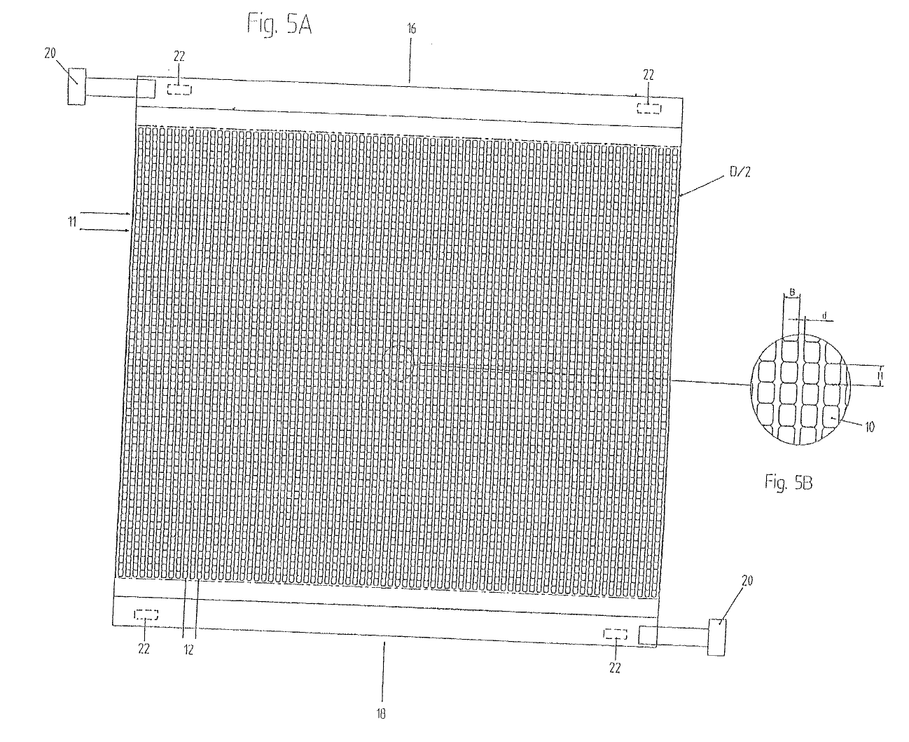

FIG. 4 a presentation for the explanation of the filling coefficient of a display surface,

FIG. 5A a schematic presentation of an LCD-pixel-matrix element from the front,

FIG. 5B an enlargement of FIG. 5A,

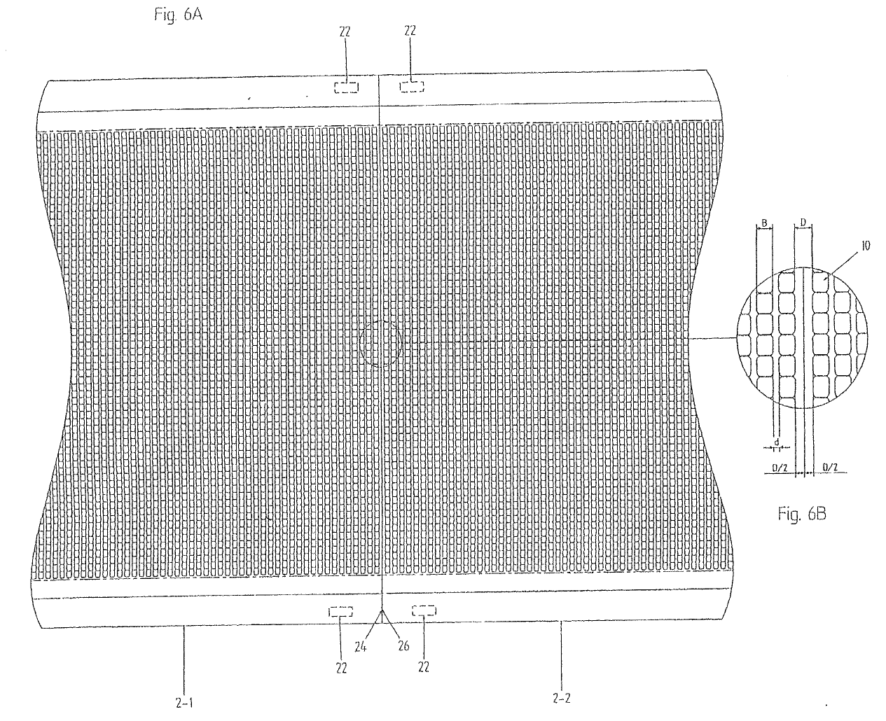

FIG. 6A a presentation of two adjacent LCD-pixel-matrix elements, and

FIG. 6B a detailed enlargement of an adjacent area of FIG. 6A.

The FIGS. 1A and 1B show, as an example, a screen panel in accord with the present invention, having a rows 3 and 4 and five columns of LCD-pixel-matrix elements, 2 which are placed adjacent to and above/under one another. In the upper row 3, are to be found four matrix elements 2-1 to 2-4 and in the lower row 4 are located five matrix elements 2-5 to 2-9. The physical outline of the entire screen mounting is rectangular, and likewise, the pixel-matrix elements are also rectangular. In the upper row 3 is located, instead of a fifth pixel-matrix element, a free area 5, which is dedicated to a constant printed designation on the display screen—in FIG. 1A, for this purpose, a “13” is shown. In this same free area 5 is to be found a light sensing device 6, by means of which the degree of brightness of the display is automatically adjusted to the degree of ambient illumination. The pixel-matrix elements 2 are individually of the same size.

FIG. 2 shows in schematics, a block diagram of a circuit, by means of which the brightness of the LCD-pixel-matrix elements 2 are controlled to adapt to the surrounding ambient light. Each pixel matrix element 2 possesses one display area 8 in which a plurality of pixels 10 is aligned in rows 11 and columns 12. The signal of brightness from the light sensor 6 is conducted to a control circuit 14. The control circuit 14 changes the control voltage V_{LCD} in correspondence with the brightness signal from the sensor 6, with which the individual LCD-pixel-matrix elements 2 are regulated. The control circuit 14 advances, accordingly, the voltage V_{LCD} to higher values in accord with higher values of the ambient lighting. This is depicted in FIG. 3, in which the transmissivity T of a pixel 10, is expressed as a function of the control voltage V_{LCD}. In the case of lesser ambient levels of illumination and a control voltage V_{LCD1} this leads to the paired V_{off1} and to Vₒₙ₁ and upon higher illumination a control voltage of V_{LCD2} regulates the paired voltages V_{Off2} and V_{On2}.

Additionally, that is, alternatively, the legibility can also be influenced by the so-called filling coefficient η and the pixel density, that is, the number of pixels per unit area of the display surface 8. It has been empirically determined, that with a filling coefficient η in a range between 40 and 95%, preferably in a range between 50 and 87%, and especially advantageous in the range between 60 and 85% and with a pixel density of 2 to 30 pixels per square centimeter, a very good readability is achieved for the display and at the same time, there is still space allowed for the wiring. FIG. 4 shows, in a schematic manner, the definition of the filling coefficient η as a quotient of the sum of the surfaces Fᵢof the individual pixels 10 and the entire area F of the display surface 8 of a pixel-matrix element 2.

The FIGS. 5A and 5B demonstrate an embodiment of the pixel-matrix element 2 with a plurality of pixels 10, which are aligned in rows 11 and columns 12. The shape of a single pixel 10 represents a rounded off rectangle. On the upper and the lower edge 16, 18 of the pixel-matrix element 2 are provided connecting elements 20, by means of which the individual pixel elements 2 are bound together.

Likewise, in the upper and lower edges, control circuits 22 are provided, to which the control voltage V_{LCD} is conducted, and which control the single pixel 10 by means of multiplex connections. Between the pixels 10 of the two outermost pixel divisions 14 on the left and right rims of the pixel-matrix element 2 there remains an edge-width of D/2.

As may be inferred from FIG. 5B, the individual pixels 10 possess a breadth B and a height H wherein the height H is somewhat greater than breadth B. This distance of each individual pixel 10 between two pixel rows is very minute and serves mainly for the insulation of the directly adjacent pixel 10. The distance of the pixel 10 in two neighboring columns 12 is somewhat larger and is designated with a d. The distance does not serve for the insulation of the pixels 10 from each other, but, in this space, the connection of the wiring to the individual pixels 10 is led from the control circuits 22.

FIG. 6A and 6B show two pixel-matrix elements 2-1 and 2-2, which are set alongside of one another. In this case, the two pixel-matrix elements abut with their side edges 24. 26 against one another. The directly neighboring pixel divisions on the two adjacent pixel matrix element 2-1 and 2-2 then lie at a distance D one from the other, respectively D/2 on both matrix-elements. This distance at maximum is equal to the doubled offset d and the pixel breadth B. That is, the distance D is smaller or equal to the empty space which arises when in a pixel-matrix element 2 a pixel column 14 is omitted. In this manner, there arises a equal-shaped optical impression, when two pixel matrix elements 2 are placed beside one another.

### Reference List

2-i LCD-Pixel-matrix element

3 Upper row of the display

4 Lower row of the display

5 Free area

6 Light sensor

8 Display surface

10 Pixel

11 Pixel rows

12 Pixel columns

14 Control circuit

16 Upper edge of 2

18 Lower edge of 2

20 Connection elements

22 Control circuit

24 Left side edge of 2

26 Right side edge of 2

Claimed is:

1. An LCD-pixel-matrix element (8) having a display surface, which comprises optically active surfaces in the form of pixels (10) and non-optically active surfaces for the electrical connections between the individual pixels, a multiplex control apparatus activated by an LCD-control voltage (V_{LCD}) for the regulation of the individual pixels (10) with a voltage which lies between a maximum and a minimum voltage value, in order to bring the said individual pixels into a condition between a maximum and minimum transmissivity, a sensing device (6) for the determination of the ambient incident brightness and for the producing of a brightness signal, and an apparatus (14) for the changing of the LCD-control voltage (V_{LCD}) in accord with said brightness signal.

2. An LCD-pixel-matrix element (8) having a display surface, which comprises optically active surfaces in the form of pixels (10) and non-optically active surfaces for the electrical connections between the individual pixels, therein characterized, in that the ratio (η) of the optically active surfaces (ΣFᵢ) to the entire display area (F) lies in a range between 40 and 90%, preferably in a range between 50 and 87% and most favorably in a range between 60 and 85%, and that the display surface (8) possesses a pixel density of 2 to 30 pixel/cm².

3. An LCD-pixel-matrix element in accord with claim 1 or 2, therein characterized, in that the display surface (8) is rectangular, in that the plurality of pixels (10) is aligned in rows (11) and columns (10), in that the individual pixels (10) in the row direction possess a certain breadth (B) which defines the dimension of the inter-pixel separation distance and in that the individual pixel columns (12) are aligned at a specified distance from one another, and that the connection elements (20) and the control circuitry (22) is placed in the upper and the lower edge areas (16, 18) pf tje rectangular LCD-pixel-matrix elements (2).

4. An LCD-pixel-matrix element in accord with one of the foregoing claims, therein characterized, in that the individual pixels, in regard to shape and size, are essentially identical.

5. An LCD-pixel-matrix element in accord with claim 4, therein characterized, in that the individual pixels (10) are rectangular and exhibit rounded corners.

6. An LCD-pixel-matrix element in accord with one of the foregoing claims, therein characterized, in that the pixels (10) are combined in a plurality of color groupings which exhibit different colors.

7. An LCD-pixel-matrix element in accord with claim 6, therein characterized, in that there are provided three color groupings for the three basic colors red, green and blue of the additive color-mixtures, that is, for the corresponding basic colors yellow, magenta and cyan of the subtractive color-mixtures.

8. An LCD-pixel-matrix element in accord with claim 6, therein characterized, in that the pixels (10) are combined in columns or rows in the color groupings and respectively two directly adjacent pixel columns (12) or pixel rows (11) are of different colors.

9. An LCD-pixel-matrix element in accord with one of the foregoing claims 6 to 8, therein characterized, in that the color groupings are made available through corresponding color filters behind the display surface (8).

10. An LCD-display panel capable of graphic exhibition with a plurality of rectangular LCD-pixel-matrix elements (2) placed adjacently to one another, in accord with one of the foregoing claims, wherein the connection elements (20) and the control circuitry (22) are placed in the upper and lower edge areas (16, 18) of the LCD-pixel-matrix elements (2), and wherein the immediately neighboring pixel columns (12) of two adjacently placed LCD-pixel-matrix elements (2) are located at a distance (D) from one another, wherein the said (D) fulfills the following equation:
D≦B+2d.

11. An LCD-display panel in accord with claim 10, therein characterized, in that at least two LCD-pixel-matrix elements (2) are placed with their upper or lower edge areas (16, 18) overlapping, and in that adjacently situated LCD-pixel-matrix elements (2) in one plane abut one another.

12. An LCD-display panel in accord with claim 10 or 11, therein characterized, in that the LCD-pixel-matrix elements (2) are protected by a transparent coating, and in that the said overlay possesses an anti-reflection layer in the form of an optical enhancement.

13. A procedure for brightness control of one or more LCD-pixel-matrix elements (2) or an LCD-display panel in accord with one of the foregoing claims, wherein a plurality of pixels (10), is controlled by means of multiplexing and is operated between a maximum voltage (V_{MAX}) and a minimal voltage (V_{MIN}) in order to bring the individual pixels into a condition between a maximum and minimum transmissivity, and whereby this pair of voltage values arise from an LCD-control voltage with which the LCD-pixel-matrix elements (2) is controlled, therein characterized, in that the LCD-control voltage (V_{LCD}), upon a greater ambient illumination, is raised to higher values.
